(19) United States
(12) Patent Application Publication
(10) Pub. No.: US 2008/0294505 A1
(43) Pub. Date: Nov. 27, 2008

(54) METHODS AND SYSTEMS FOR TASK ASSESSMENT MANAGEMENT

(76) Inventors: Aaron F. Markowitz, Huntsville, AL (US); Gregory P. Bowman, Madison, AL (US)

Correspondence Address: JOHN S. BEULICK (24691);ARMSTRONG TEASDALE LLP, ONE METROPOLITAN SQUARE, SUITE 2600, ST. LOUIS, MO, 63102-2740, US

(21) Appl. No.: 11/752,692

(22) Filed: May 23, 2007

(51) Int. Cl. G06F 11/34; G06F 17/30

(52) U.S. Cl. 705/11; 705/9; 707/4

(57) ABSTRACT

Methods and systems for managing an assessment of tasks using a computer implemented task assessment management system are provided. The method includes generating a program objective by a customer that defines an end-product to be supplied to the customer by a contractor and generating a plurality of tasks that support supplying the end-product to the customer, the plurality of tasks including at least one metric that defines the performance of the task to support supplying the supplying the end-product to the customer. The method also includes evaluating the contractor performance in completing each of the plurality of tasks using the respective at least one metric, the self-assessment stored in a memory of the task assessment management system and evaluating the contractor performance in completing each of the plurality of tasks by the customer using the respective at least one metric and the self-assessment.

### BACKGROUND

The invention was made with Government support under Contract No. HQ0006-01-C-0001 awarded by U.S. Army Ballistic Missile Defense Organization Missile Defense Agency. The Government has certain rights in this invention.

This disclosure relates generally to managing assessments of task performance and more particularly, to methods and systems for establishing task goals, managing assessments of the tasks and determining task metrics with respect to the task goals.

At least some known project management systems are generally concerned with work flow management rather than performance of a contractor in relation to individual tasks. Contractors, suppliers, or other business entities that provide services to customers have not provided a self-assessment of their own task completion performance to the customer. Normally, the contractor provides the customer with a narrative of progress made towards the project objective in a spreadsheet or text document. In such cases, collaboration between the contractor and the customer is limited.

Typically, managing the progress of tasks and communicating progress to a customer at any level of a large system is difficult, time consuming, and extremely expensive. Because of such difficulty, inaccurate assessment of contractor performance with respect to project goals may permit award and incentive fees payment regardless of performance outcome. Paying incentive fees and awards when they may not be deserved reduces the effectiveness of the incentive process.

Methods and systems are needed for accurate assessment of contractor performance and management of the assessment process to facilitate coordinating task assignments, performance documentation, and feedback.

### SUMMARY

In one embodiment, a method of managing an assessment of tasks using a computer implemented task assessment management system includes generating a program objective by a customer that defines an end product to be supplied to the customer by a contractor, the program objective stored in a memory of the task assessment management system that is accessible to the customer and the contractor and generating a plurality of tasks that support supplying the end product to the customer, the plurality of tasks including at least one metric that defines the performance of the task to support supplying the end product to the customer, the plurality of tasks stored in a memory of the task assessment management system that is accessible to the customer and the contractor The method also includes evaluating the contractor performance, by the contractor, in completing each of the plurality of tasks using the respective at least one metric, the self assessment stored in a memory of the task assessment management system that is accessible to the customer and the contractor and evaluating the contractor performance in completing each of the plurality of tasks by the customer using the respective at least one metric and the self assessment.

In another embodiment, a system for managing an assessment of tasks includes a client system comprising a browser, a database for storing task information including a program objective and information describing at least one task that supports supplying an end-product defined by the program objective to a customer, and a server system configured to be coupled to the client system and the database. The server system is configured to display information on the client system identifying the program objective to a user, receive a plurality of tasks that implement supplying the end-product to the customer, receive criteria used to evaluate the performance of a contractor in completing the plurality of tasks, and display to the contractor and the customer information entered into the system by the contractor and the customer, the information relating to the performance of the contractor with respect to the criteria, an assessment of the contractor performance with respect to the criteria based on the information, and a response from the contractor to the customer assessment of the contractor performance during the task.

In yet another embodiment, a method of determining a contract fee award using a computer implemented task assessment management system includes generating a plurality of tasks supporting a program objective, the plurality of tasks including at least one metric that defines the performance of the task in supporting the program objective, the plurality of tasks stored in a database of the task assessment management system, the database being accessible to the customer and the contractor. The method also includes self evaluating the contractor performance, by the contractor, in completing each of the plurality of tasks using the respective at least one metric, the self assessment is stored in a memory of the task assessment management system that is accessible to the customer and the contractor and evaluating the contractor performance in completing each of the plurality of tasks by the customer using the respective at least one metric and the self assessment. The method further includes responding to the customer assessment by the contractor using information relating to the performance of the contractor stored in the database, the information acquired from the customer and the contractor during performance of the task, generating a corrective action plan that realigns at least one of the plurality of tasks based on the program objective and the performance of the plurality of tasks up to the assessment, and determining a fee award based on the performance of the tasks with respect to the associated metric and the information stored in the database.

### BRIEF DESCRIPTION OF THE DRAWINGS

FIG. 1 is a simplified block diagram of a Task Assessment Management System (TAMS) including a server system, and a plurality of client sub-systems, also referred to as client systems, connected to server system;

FIG. 2 is an expanded block diagram of an exemplary embodiment of a server architecture of a TAMS;

FIG. 3 is a flow chart of an exemplary method of task assessment management in accordance with an embodiment of the present disclosure;

FIG. 4 is a data flow diagram of an exemplary embodiment of TAMS illustrating a tiered architecture of the system;

FIG. 5 is a screen capture of an exemplary splash page for TAMS in accordance with an embodiment of the present disclosure;

FIG. 6 is a screen capture of dashboard navigation selection shown in FIG. 5 in accordance with an exemplary embodiment of the present disclosure;

FIG. 7 is a screen capture of an exemplary self assessment entry screen in accordance with an embodiment of the present disclosure;

FIG. 8 is a screen capture of an exemplary customer comment screen in accordance with an embodiment of the present disclosure;

FIG. 9 is a screen capture of an exemplary comment disposition page in accordance with an embodiment of the present disclosure; and

FIG. 10 is a screen capture of an exemplary actionable comments activity plan in accordance with an embodiment of the present disclosure.

### DETAILED DESCRIPTION

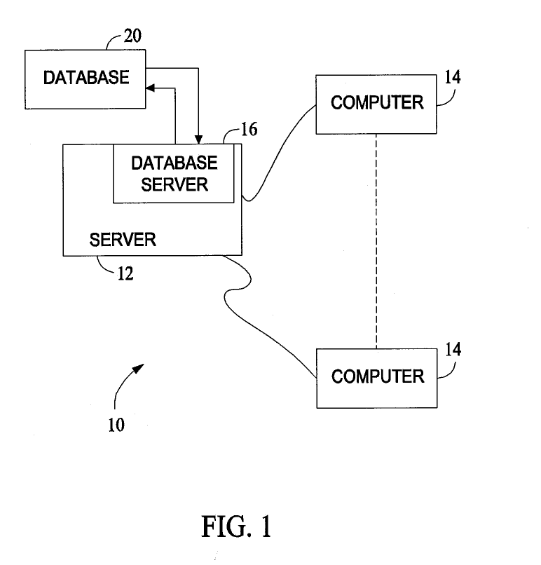

FIG. 1 is a simplified block diagram of a Task Assessment Management System (TAMS) 10 including a server system 12, and a plurality of client sub-systems, also referred to as client systems 14, connected to server system 12. Computerized modeling and grouping tools, as described below in more detail, are stored in server 12, and can be accessed by a requester at any one of computers 14. In one embodiment, client systems 14 are computers including a web browser, such that server system 12 is accessible to client systems 14 using the Internet. Client systems 14 are interconnected to the Internet through many interfaces including a network, such as a local area network (LAN) or a wide area network (WAN), dial-in-connections, cable modems, and special high-speed ISDN lines. Client systems 14 could be any device capable of interconnecting to the Internet including a web-based phone, personal digital assistant (PDA), or other web-based connectable equipment. A database server 16 is connected to a database 20 containing information on a variety of matters, as described below in greater detail. In one embodiment, centralized database 20 is stored on server system 12 and can be accessed by potential users at one of client systems 14 by logging onto server system 12 through one of client systems 14. In an alternative embodiment, database 20 is stored remotely from server system 12 and may be non-centralized.

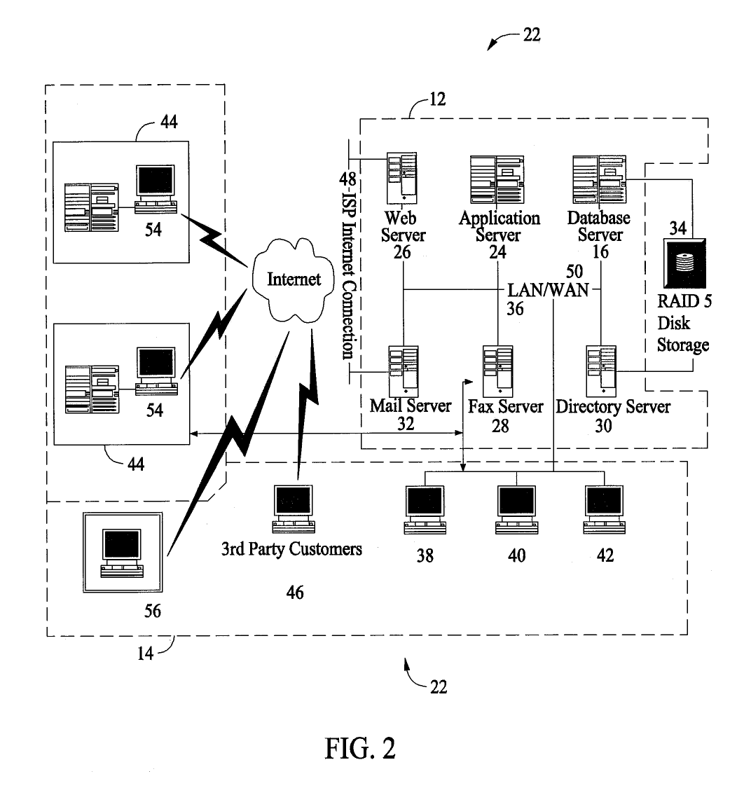

FIG. 2 is an expanded block diagram of an exemplary embodiment of a server architecture of a TAMS 22. Components in system 22, identical to components of system 10 (shown in FIG. 1), are identified in FIG. 2 using the same reference numerals as used in FIG. 1. System 22 includes server system 12 and client systems 14. Server system 12 further includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 using an Internet link or are connected through an Intranet.

Each workstation, 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

Server system 12 is configured to be communicatively coupled to various individuals, including employees 44 and to third parties, e.g., customers/contractors 46 using an ISP Internet connection 48. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 50, local area network 36 could be used in place of WAN 50.

In the exemplary embodiment, any authorized individual having a workstation 54 can access TAMS 22. At least one of the client systems includes a manager workstation 56 located at a remote location. Workstations 54 and 56 are personal computers having a web browser. Also, workstations 54 and 56 are configured to communicate with server system 12. Furthermore, fax server 28 communicates with remotely located client systems, including a client system 56 using a telephone link. Fax server 28 is configured to communicate with other client systems 38, 40, and 42 as well.

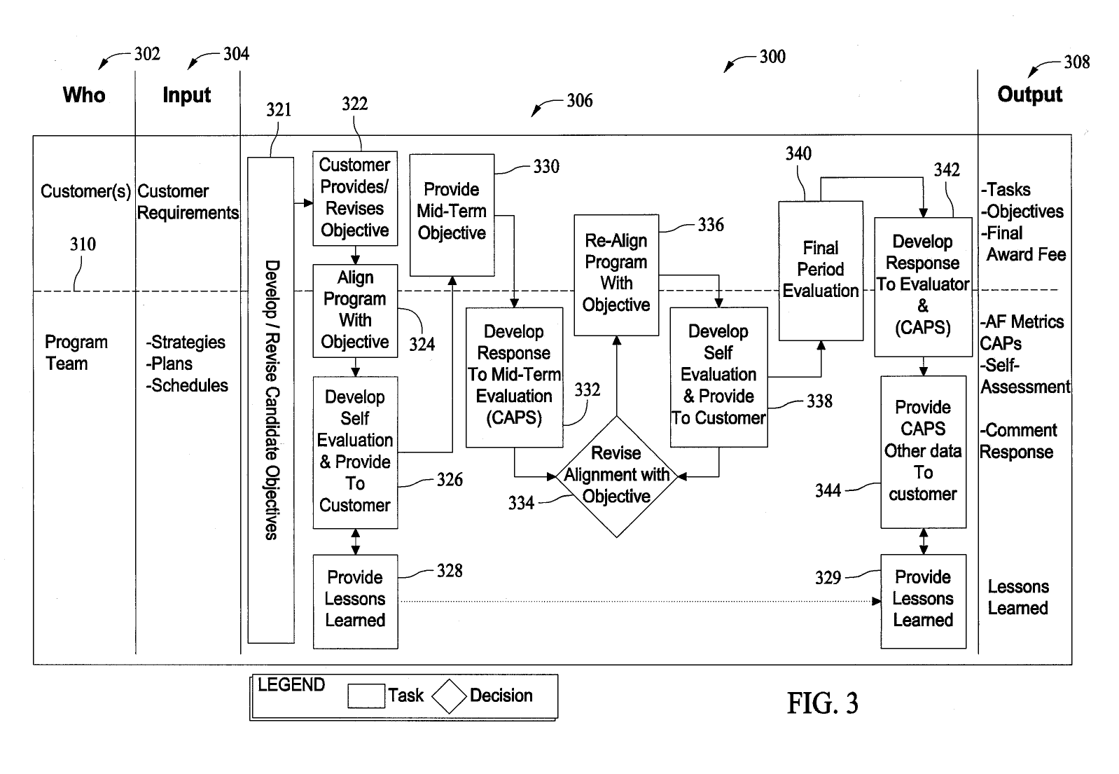

FIG. 3 is a flow chart of an exemplary method 300 of task assessment management in accordance with an embodiment of the present disclosure. Although described in the context of an award fee management system other management implementations are envisioned. The flow chart is divided into a responsibility area 302, an input area 304, a process area 306, and an output area 308. A division line 310 demarcates the associated organizations responsible for the steps falling in their respective process area. Steps falling on one of the division lines are shared between the organizations represented on either side of the line.

In the exemplary embodiment, TAMS is used to define and assess award fee achievement for a business entity such as a contractor, customer(s), and suppliers or subcontractors. Specifically, TAMS provides structure and process flow designed to facilitate creation of task goals with measurement criteria, assessment of the metrics associated with each task goal, and an assessment of the achievement of the task goals in relation to an award fee.

Method 300 includes developing jointly 321 or receiving from the customer 322, the objectives for the project. As used herein, objectives define the overall program outcome, for example, a customer may request the contractor to build an aircraft. The objectives are used to define the aircraft in terms of for example, but not limited to performance, cost, operating expense, noise, and passenger or range capability. A program that supports the customer objective is aligned 324 with those objectives. The entity and customer and any subcontractors the entity may anticipate using to support the program determine the tasks that are necessary to accomplish the program. The aligning 324 step may entail various levels of detail for each different program and may also entail an extensive collaborative effort wherein tasks are defined and redefined based on optimizing the tasks to achieve the customer objective.

Each task in TAMS may be assigned a responsible party within the entity that is charged with directing and managing program team members and tasks associated with specific assessment criteria. Additionally, the responsible party permits the tasks and all associated assessments and comments to be sorted by the respective responsible party, providing additional insight and metric collection not previously available. A self assessment is developed 326 and provided to the customer. Each task is assessed internally either periodically such as weekly, monthly, or quarterly or continuously in real-time. The assessment periodicity is defined in and maintained using TAMS. TAMS provides the functionality for responsible parties to enter assessments assigned to them, review them internally, and then share their reviewed assessments with the customer. The architecture of TAMS, which provides immediate and up-to-date electronic access to all authorized personnel, enables co-authoring and sharing of relevant task-assessment data in a timely and cost-efficient manner.

Data is stored electronically in TAMS and functionality is provided to access prior assessments. TAMS also tracks metrics showing the completion of self assessments, comment responses and action plans. These metrics are generated to capture commonality and trends to facilitate lessons learned 328 that can be presented from each program using TAMS to any other program. Lessons learned 328 may also be integrated into later steps of method 300 as shown at step 329.

In the exemplary embodiment, a mid-term assessment is developed 330 by the customer. In some cases the entity is a customer to the subcontractors and the entity would be evaluating the subcontractor's performance in this step. Self assessments and comments are stored electronically and are packaged together and parsed to generate a midterm assessment at any point in the process timeline. This mid-term assessment may contain scoring, other objective measures of progress, or subjective comments addressing the objectives provided in 322.

A response to the mid-term assessment is developed 332 by the entity to provide information to the customer to improve assessment accuracy. The response may prompt an iterative revision of the mid-term assessment from the customer until the customer and entity are in agreement with the assessment. All the information necessary to perform the assessment and develop the response is available to both parties in real-time such that communication is facilitated with respect to the timeliness of the comments and responses, time to prepare respective documents, and because the information is known to both parties during the entire term of the period. As described above, in some cases such as when the entity is a customer to the subcontractors, the subcontractors may provide a mid-term assessment response to the entity.

With comments provided by the customer electronically across the firewall, each contractor responsible party can respond to each comment and generate Corrective Action Plans (CAPS), which are also tracked to completion in TAMS. Additionally, comment responses and assessments are categorized and used to generate metrics regarding the assessments and responses.

An assessment 334 as to whether a realignment of the program is necessary to support the customer objective. For example, assumptions made during an initial alignment may no longer be realistic or realizable. The customer may have made changes to the objective or the assumptions made as to manufacturing and fabrication uncertainties may not have been met of may have been exceeded providing an opportunity to capture and utilize the lessons learned to date when realigning the program tasks to the objective.

Realigning 336 the program with the objective is a joint effort as indicated by the placement of the block representing step 336 on both sides of line 310 dividing the responsibilities of method 300. A realignment may be needed for a variety of reasons and TAMS is a nimble platform that facilitates such realignment. Both parties revise their data in the TAMS system, which is then available in real-time to the other party.

Using the newly realigned tasks or the original tasks if realignment was determined not to be necessary, self assessment is developed 338 and transmitted to the customer. TAMS permits the program team to develop detailed self-assessments and provide to the customer whenever the program team elects to send the latest iteration across the firewall to customer assessors. This electronic sharing permits for more frequently updated assessments, which leads to a more complete dialogue between the customer describing what they want and the contractor describing how they will meet those customer needs.

TAMS automatically assimilates 340 all the self assessments, customer comments, and comment responses from the entire period into a single package with credible data to support the contractor position. The package permits the program team to prepare for a joint meeting with the customer or to provide the customer with the package, when the customer elects to hold a closed session. Because the data is electronically stored in TAMS, the most up-to-the-minute information can be quickly gathered and assimilated to form the best package possible.

A response to assessment is developed 342 that includes the corrective action plans. TAMS may be utilized to develop a response to the customer's final assessment and provide that response across the firewall to the customer, providing another iteration of dialogue that facilitates achieving accurate assessments and awards.

CAPS and other data may be provided 344 to the customer. With both the customer and the contractor on the same TAMS, any assessment and corrective action plan can be generated and provided to the customer through electronic data sharing.

To provide the most accurate program-picture possible, customer and contractor tiers interact with each other to fulfill the complete process. The customer level first defines tasks. As the contractor is completing the tasks, they perform self assessments and the customer evaluates the contractor's performance. The contractor then uses TAMS 10 to present its self assessments to the customer, so the customer can use the self assessments to arrive at a more accurate assessment. After the assessment and comments have been completed to reflect performance during a specified period, the customer then sends the comments and assessments to the contractor for response. The contractor can then elect to respond to the comments and provide some or all of these responses across the firewall to the customer for assessment and potential incorporation into the final assessment. In the award-fee structure, both sides are then able to use the system to generate the final report as inputs to the final review-board assessment. At every step TAMS 10 generates metrics and other calculations so that an up-to-date high-level progress report is always available.

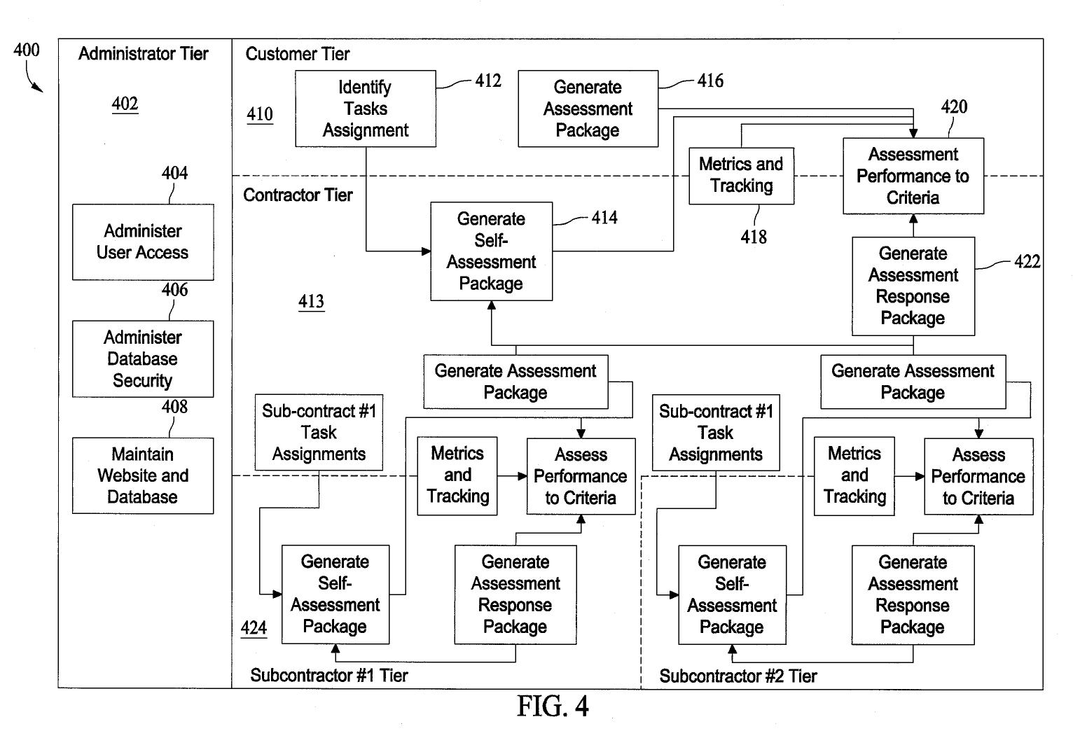

FIG. 4 is a data flow diagram of an exemplary embodiment of TAMS illustrating a tiered architecture 400 of the system. In the exemplary embodiment, an administrator tier 402 includes a user access module 404 configured to maintain information relating to authorized users, authorized permissions to edit, add, and/or delete data in the system, as well as tracking algorithms for monitoring access. A database security module 406 is configured to monitor database activity and intelligently permit or deny changes to the data, uploading and downloading of the data stored in the TAMS database. A database and website maintenance module 408 is configured to provide tools to facilitate operation of the TAMS web server and network connections as well as tools for optimizing the operation of the database.

A customer tier 410 includes an Identify Tasks Assignment block 412 that begin the task assessment management process. Generally a customer defines an objective to support their business and looks to another business entity to supply the objective. For example, an airline may determine it has a need for additional aircraft. The airline defines the requirement to be fulfilled by the aircraft and looks to another entity such as an aircraft manufacturer to augment the requirements and supply the aircraft. In the exemplary embodiment, Identify Tasks Assignment 412 is illustrated as being performed by the customer alone, but in many instances, the customer and the contractor work together to define the objective.

Once the objective is determined and transmitted to the business entity or contractor in a contractor tier 413, the contractor generates a self assessment package 414. Self assessment package 414 includes a breakdown of tasks required to meet the objective, metrics for the performance of those tasks and fee awards that are associated with achieving the metrics defined for each task. For example, some tasks may be required to be completed before the next task begins. Other tasks may be able to run concurrently with other tasks and may also be able to be worked independently of some tasks. There may be an incentive to award fees on a sliding scale for early completion of some tasks to facilitate beginning the next task. Fee awards may include fact intensive inquiries that also require negotiation by the parties to achieve a meaningful fee award system.

The customer may also generate an assessment package 416 that is also used to evaluate the business entity's performance with respect to completing the tasks timely and efficiently.

During performance of the tasks, each task is evaluated with respect to the metrics determined for that task. The assessments are performed in real-time and entered into TAMS 10 where they are available on an ongoing basis to all parties having access to that data. At various predetermined periods during the performance of the tasks, intermediate assessments to the objective criteria may be performed. TAMS 10 is configured to generate assessments of performance to criteria 420 using data already stored in TAMS 10. The assessments may be evaluated as a joint meeting between the customer and the entity or the customer may elect to perform the assessment independent of the entity. In either case, both parties have access to the same data that was entered by both parties during the performance period being evaluated.

As a result of the assessment of performance to criteria 420, a series of corrective action plans may be generated and assembled into an assessment response package 422. Assessment response package 420 may include corrective action plans (CAPS) for realigning the task performance with the objective.

TAMS 10 is scalable to permit repeating the basic assessment management structure over any number of subcontractors 424 to contractor 413. Each assessment process may be duplicated for any number of subcontractors in a subcontractor tier. The customer or Upper Tier is used by the customer to access TAMS 10. Users at the customer level can define tasks, evaluate contractor performance, deliver comments and assessments to the contractor users, review contractor self assessments, review customer responses to assessments and comments, and generate customer metrics and assessment packages. The contractor or Lower tier controls contractor accesses and uses. Users at this level can perform self assessments, respond to comments, generate and track corrective action plans, submit self assessments and/or comment responses to the customer, and generate contractor metrics and assessment packages. The electronic nature of all levels being on the same TAMS 10 also can allow customer insight to the assessments and performance of the subcontractor level as provided by the contractor.

TAMS 10 is configurable to assign specific parties to access specific assessments for tasks that are agreed upon between the parties. Other parties, such as the customer and/or other subcontractors may be granted permission to view and/or change the assessments or add assessments to tasks as may be necessary or desired.

TAMS provides a disciplined process utilizing a common workspace for documentation of accomplishments and mitigating factors for each element of the criteria. A common process and a common place to record specific information to document progress towards the objective facilitates cooperation amongst the users. TAMS provides a ‘wiki-like’ environment that allows users to create and edit TAMS database content using any Web browser. However TAMS includes added controls for accountability and visibility. This environment permits and encourages a large, distributed group to work rapidly in parallel, to author and/or evaluate assessments, as opposed to reviewing a monolithic document in serial fashion. Because TAMS is configured to facilitate assessment rather than documentation or configuration management, TAMS directs the users to the criteria they are responsible for addressing.

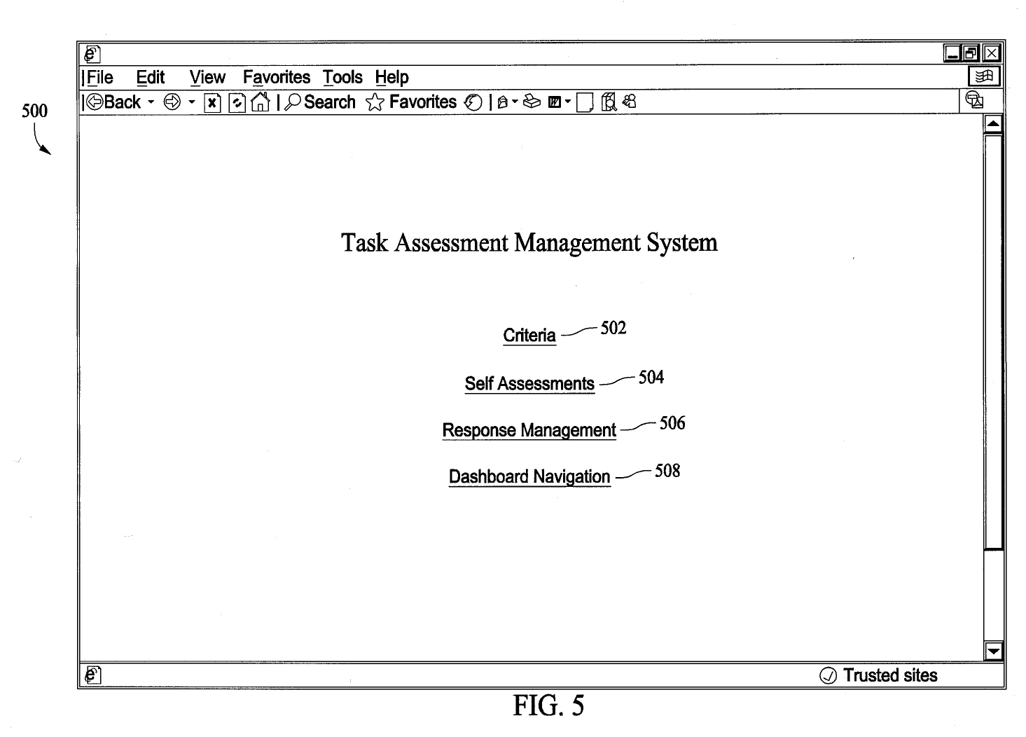

FIG. 5 is a screen capture of an exemplary splash page 500 for TAMS 10 in accordance with an embodiment of the present disclosure. In the exemplary embodiment, TAMS includes at least three modules that organize the functionality of TAMS 10. A criteria selection 502 includes a description of the tasks to be assessed, accountability for each, and the relative or absolute value of each task. An assessment selection 504 provides a framework in which self assessments and customer assessments of the tasks can be developed and/or collaborated between those self-assessing their performance and those rating the performance. A response management selection 506 provides structure for the categorization and rebuttal to or agreement with captured assessment comments. It also facilitates the creation and disposition of corrective action plans (CAPS) for those assessments for which follow-up is indicated.

Along with each of these modules, an administrative tier of functions are available for those with an administrative role in the process that is selectable using a dashboard navigation selection 508. Management of users and their roles, system metrics, and bulk data download are examples of the administrative functions available in TAMS. Roles for each user are established to define and manage access to various views of the functionality and data in TAMS.

TAMS provides detailed program-level documentation and tracking of a contractor or supplier's progress toward meeting customer-assigned tasks such as those found in award-fee criteria and provides an accurately detailed program-level report on a contractor's and/or subcontractor's progress toward meeting customer-assigned tasks. As a business tool, TAMS facilitates directing efforts to tasks that will meet customer-identified deficiencies more quickly and more accurately, providing the contractor with an improved opportunity to achieve higher award fees in a performance-driven environment.

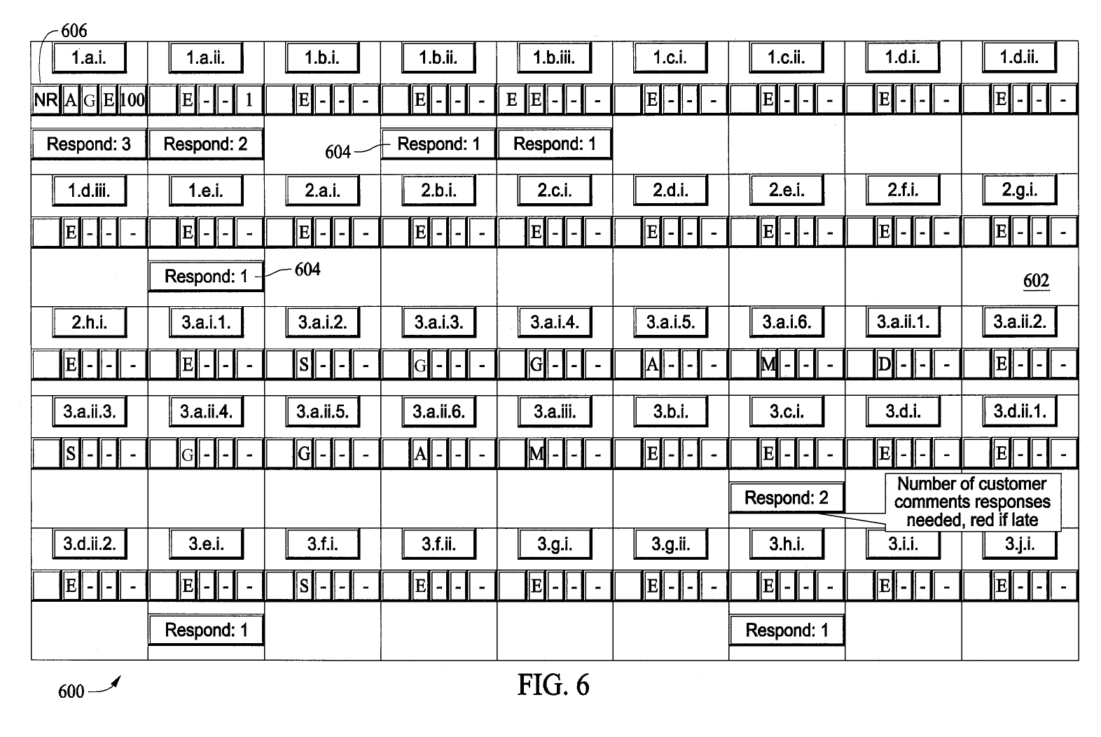

FIG. 6 is a screen capture of dashboard navigation selection 508 (shown in FIG. 5) in accordance with an exemplary embodiment of the present disclosure. In the exemplary embodiment, dashboard navigation selection 508 screen includes a task box 602 for each task or criteria. Each task box 602 is colored-coded to provide a user an indication of the status of the task. For example, a green color-code may indicate that the task is on-plan and/or is rated exceptional. A yellow color-code may indicate that the task is behind the activity plan and/or that a recovery plan is in place. A red color-code may indicate that the task is behind the activity plan and/or that a recovery plan is not in place or the task is not able to be aligned will the criteria. A white color-code may indicate that a particular task is awaiting authorization or is otherwise not being measured.

When a comment or entry for which a response is needed is entered for a task, a comment button 604 is displayed overlaid on a portion of task box 602. Each comment button 604 is also color-coded to provide a user an indication that information and/or a response may be due for that task. For example, an entered comment may have a predetermined response time associated with the particular class of comment. Routine comments may be permitted to be unanswered for a longer time period than comments that are determined to be more time critical. Additionally, a user entering the comment may specify a deadline for a response. If a comment for a task is unanswered for a time period exceeding the deadline, comment button 604 may be color-coded red. An email or other communication may also be generated to alert a responsible party that the comment has gone unanswered for a period approaching and/or exceeding the associated deadline.

Each task box 602 includes an associated rating bar 606 that permits a rating of the task for one or more time periods. For example, for the task associated with criteria “1.a.i,” a self assessment indicates “NR” for “not rated.” A first quarter customer rating is indicated as being “A” for “Average,” a second quarter rating is indicated as being “G” for “Good,” a third quarter customer rating is indicated as being “E” for “Excellent,” and a Final Rating indicates the completion of that task.

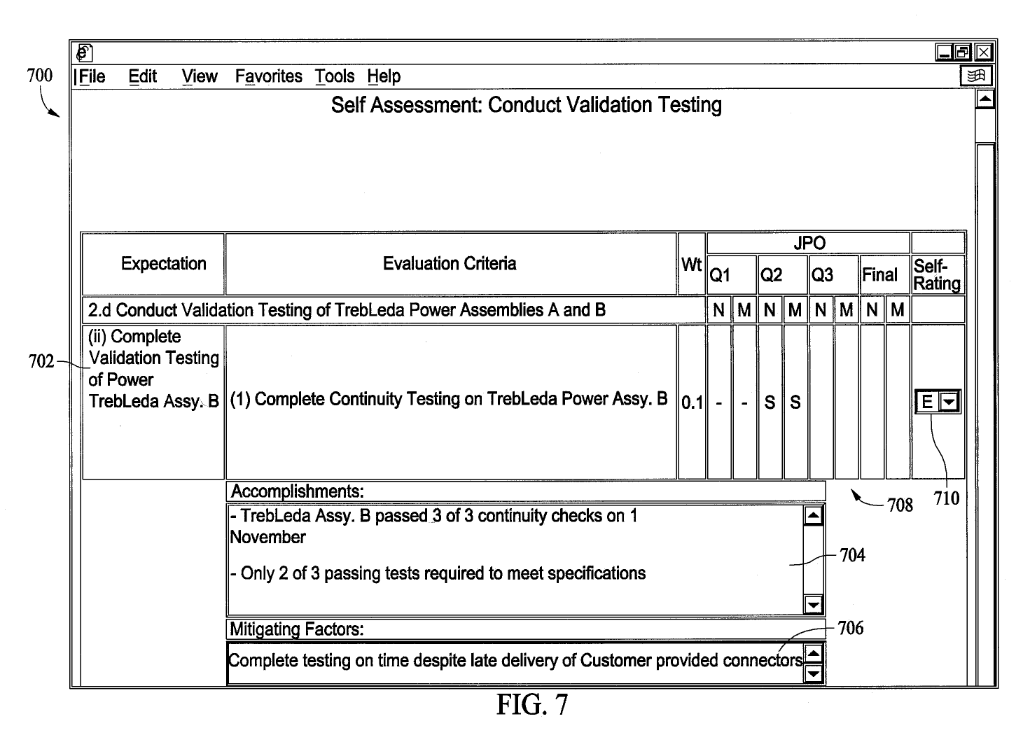

FIG. 7 is a screen capture of an exemplary self assessment entry screen in accordance with an embodiment of the present disclosure. In the exemplary embodiment, the task criterion is displayed in a criteria pane 702. Accomplishments toward completing the task are entered into an accomplishments pane 704 as they occur. Mitigating factors that identify factors that can mitigate negative indications of events beyond the control of the contractor or negative events mitigating downward artificially high objective measurements are entered in a mitigating factors pane 706. Previous period ratings are displayed in a ratings pane 708. A self-rating for the task is entered in a self rating pane 710. Self assessments are generally identified in real-time, but may only be reported to the customer periodically, for example, semi-annually, quarterly, or other periodicity. A real-time self assessment status may be tracked and reported indicating a number of tasks that have been assessed, a percentage of the tasks that are self-assessed. Drilling down on the number of tasks displays the unassessed tasks. In addition, real-time customer response status may be tracked and reported that includes a number and percent of customer comments addressed. Drilling down on the number permits viewing the comment dispositions.

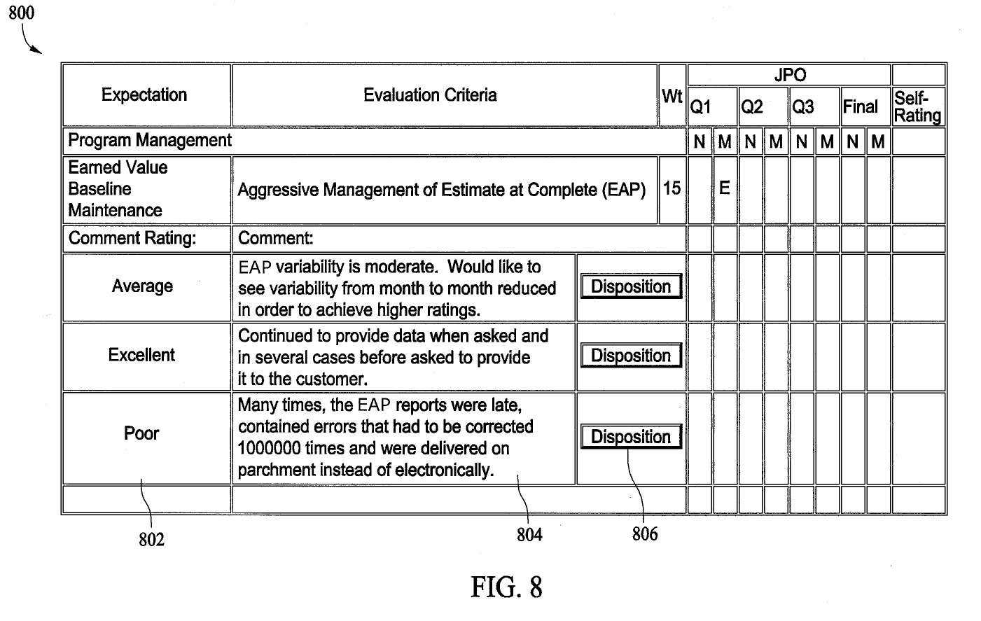

FIG. 8 is a screen capture of an exemplary customer comment screen 800 in accordance with an embodiment of the present disclosure. The comment includes a rating 802, which may comprise a numerical or coded rating indicating the customer assessment of performance of the respective task to the criteria as supported by the comment. A comment narrative 804 may be included that explains in greater detail the reasoning for comment rating 802. A disposition button 806 associated with each comment links to a comment disposition page (not shown in FIG. 8), where dispositions to customer comments are received, assigned, tracked, discharged.

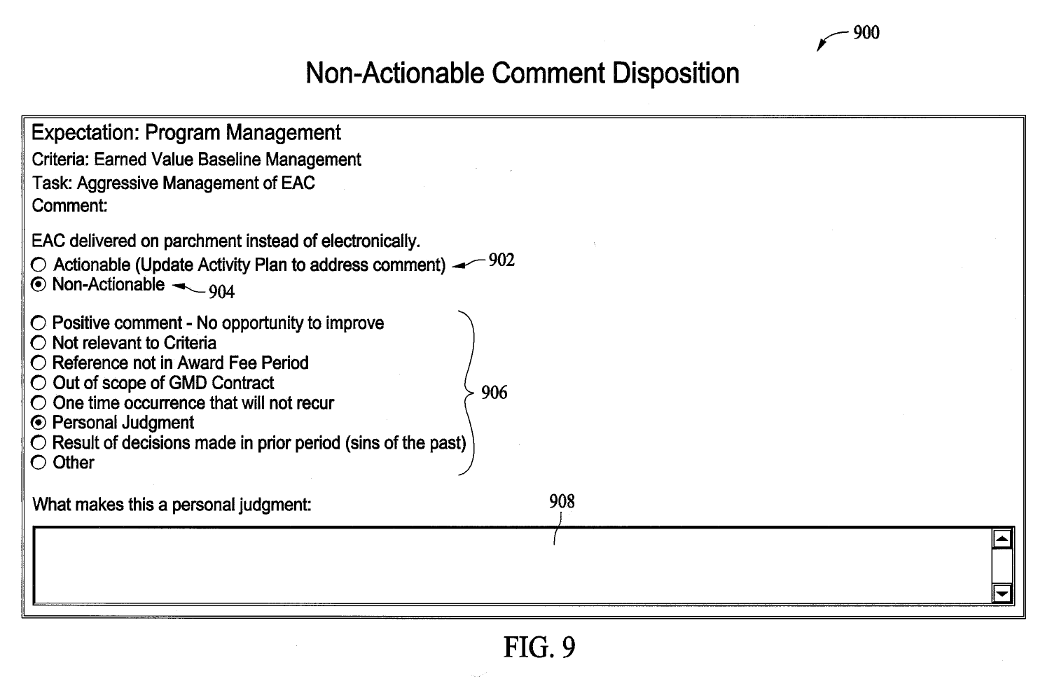

FIG. 9 is a screen capture of an exemplary comment disposition page 900 in accordance with an embodiment of the present disclosure. Comment disposition page 900 permits entry of a preliminary disposition of the customer comment. The comment may be determined to be actionable 902 wherein an actionable comment activity plan page will be used to track the disposition. If the comment is determined to be non-actionable 904, the comment will be documented and tracked for future use in preparing response to an assessment or a final report at program completion. Non-actionable comments can be categorized 906 and a narrative disposition pane is provided so they may be tracked for rebuttal or lessons learned purposes. Configuration of response categories 906 is administratively controlled in TAMS, flexibly allowing one or many categories to be defined and authorized for use.

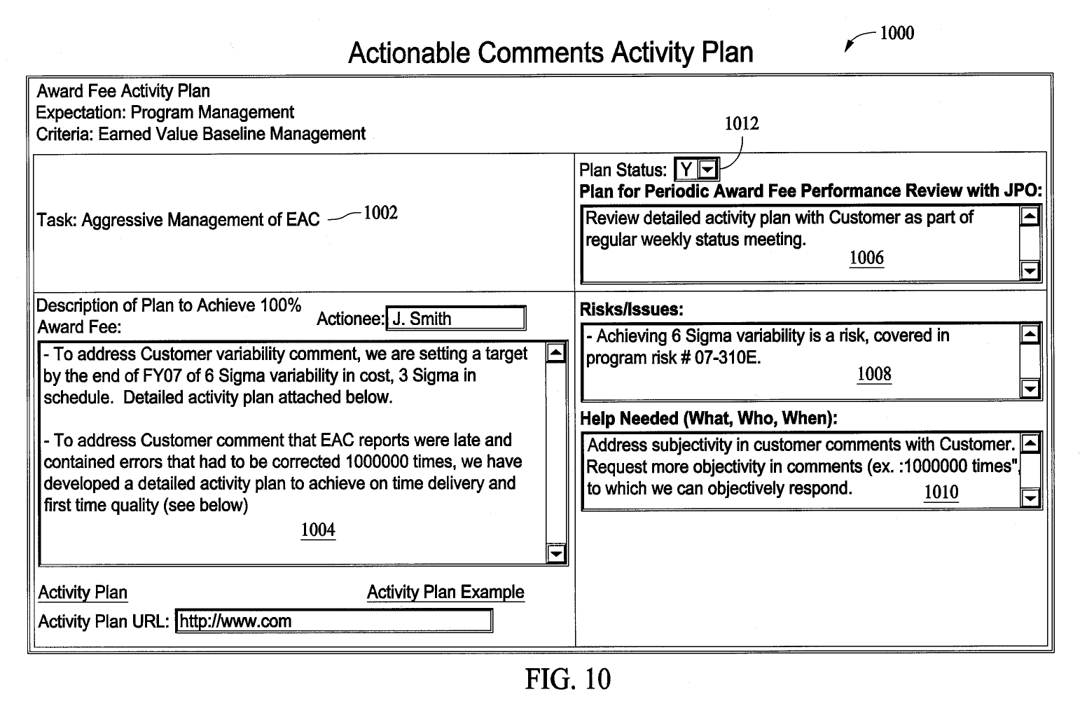

FIG. 10 is a screen capture of an exemplary actionable comments activity plan 1000 in accordance with an embodiment of the present disclosure. Actionable comments activity plan 1000 includes a description of the task 1002, a description of the activity plan 1004, which may include an attached detailed activity document linked to the description of activity plan 1004. Description 1004 also identifies a responsible person for the activity plan. Description 1006 identifies a timetable for coordinating responses with the customer. Actionable comments activity plan 1000 also includes, a risk/issues area 1008 for tracking status associated with activity plan 1004, and a support request area 1010. When an activity plan includes items that need attention the color-coding of the associated task box 602 is changed 1012 to alert a user that attention is needed.

TAMS provides an interface to facilitate detailed project-level visibility into the progress towards completion of assigned tasks, from both the vantage point of the customer and the contractor, as well as providing an electronic database to host this information. In addition to providing a platform to host the assessments, the system can be configured to automatically derive metrics in real-time from the most up-to-date information hosted by the system. TAMS aids in task assessment in projects that have multi-tier contractors. The system is scalable in that each subcontractor can use the same model in its assessment of its subcontractors while each subcontractor can also provide insight into its own subcontractors' performance and assessments to its customer. TAMS provides a mechanism for iterative feedback on task assessments, provides a record of those comments/response chains for each task and encourages a dialog/feedback mechanism on task assessment to facilitate early recognition of deficiencies, a feedback/rebuttal mechanism, and corrective action plan creation.

While the disclosure has been described in terms of various specific embodiments, those skilled in the art will recognize that the disclosure can be practiced with modification within the spirit and scope of the claims.

What is claimed is:

1. A method of managing an assessment of tasks using a computer implemented task assessment management system, said method comprising:
generating a program objective that defines an end-product to be supplied to a customer by a contractor, the program objective stored in a memory of the task assessment management system that is accessible to the customer and the contractor;
generating a plurality of tasks that support supplying the end-product to the customer, the plurality of tasks each including at least one metric that defines performance of the task to support supplying the end-product to the customer, the plurality of tasks stored in a memory that is accessible to the customer and the contractor;
storing contractor self-evaluations of task completions in a memory of the task assessment management system that is accessible to the customer and the contractor; and
evaluating the contractor performance in completing each of the plurality of tasks by the customer using the respective at least one metric and the self-assessment.

2. A method in accordance with claim 1 further comprising evaluating the performance of the contractor by the customer independent of the self-assessment.

3. A method in accordance with claim 1 wherein evaluating the contractor performance comprises rating by the customer each task and including a comment for each rating in support of the rating.

4. A method in accordance with claim 1 further comprising generating an assessment by the customer of the contractor performance on each task, the assessment including a fee award for the task.

5. A method in accordance with claim 4 further comprising generating a response by the contractor to the assessment by the customer.

6. A method in accordance with claim 5 wherein generating a response by the contractor to the assessment by the customer comprises generating a corrective action plan that is stored in a memory of the task assessment management system that is accessible to the customer and the contractor.

7. A method in accordance with claim 5 wherein generating a response by the contractor to the assessment by the customer comprises realigning at least one of the plurality of tasks with the program objective based on the assessment by the customer.

8. A method in accordance with claim 5 wherein realigning at least one of the plurality of tasks with the program objective comprises at least one of reallocating resources to the task, and adjusting a time to completion of the task.

9. A method in accordance with claim 5 further comprising self-evaluating the contractor performance, by the contractor, based on the realignment of the at least one of the plurality of tasks with the program objective.

10. A method in accordance with claim 1 further comprising evaluating the contractor performance, by the contractor, in completing each of the plurality of tasks using the respective at least one metric, the self-assessment stored in a memory of the task assessment management system that is accessible to the customer and the contractor

11. A method in accordance with claim 1 further comprising awarding at least a portion of a fee to the contractor by the customer based on the customer assessment and the contractor response to the customer assessment.

12. A method in accordance with claim 1 further comprising:
identifying at least one of ratings, comments, and comment responses associated with the plurality of tasks for determining trends in performance of the plurality of tasks;
storing the at least one of ratings, comments, and comment responses in a memory of the task assessment management system that is accessible to the customer and the contractor; and
using the determined trends when generating tasks for future program objectives.

13. A system for managing an assessment of tasks, said system comprising:
a client system comprising a browser;
a database for storing task information including a program objective and information describing at least one task that supports supplying an end-product defined by the program objective to a customer; and
a server system configured to be coupled to said client system and said database, said server system configured to:
display information on the client system identifying the program objective to a user;
receive a plurality of tasks that implement supplying the end-product to the customer;
receive criteria used to evaluate the performance of a contractor in completing the plurality of tasks; and
display to the contractor and the customer information entered into the system by the contractor and the customer, the information relating to the performance of the contractor with respect to the criteria, an assessment of the contractor performance with respect to the criteria based on the information, and a response from the contractor to the customer assessment of the contractor performance during the task.

14. A system in accordance with claim 13 wherein the plurality of tasks are generated by at least one of the customer and the contractor.

15. A system in accordance with claim 13 wherein access is controlled to allow selective visibility to information entered into the system.

16. A system in accordance with claim 13 wherein said server system is configured to receive criteria for each task that includes task start and task complete times, quality standards to be met during performance of the task, quality standards for acceptance of completion of the task, and a weighted score associated with the task based on completion of the task in accordance with the criteria.

17. A system in accordance with claim 13 wherein said server system is configured to receive a self assessment of the contractor performance with respect to the task criteria during performance of the task, the self assessment of the task is performed by the contractor.

18. A system in accordance with claim 13 wherein said server system is configured to permit access to the self-assessment by the customer.

19. A system in accordance with claim 13 wherein said server system is configured to receive customer ratings of the contractor performance with respect to the task criteria and customer comments for each task that is evaluated in the self-assessment.

20. A method of determining a contract fee award using a computer implemented task assessment management system, said method comprising:
generating a plurality of tasks supporting a program objective, the plurality of tasks including at least one metric that defines the performance of the task in supporting the program objective, the plurality of tasks stored in a database of the task assessment management system, the database being accessible to the customer and the contractor;
self-evaluating the contractor performance, by the contractor, in completing each of the plurality of tasks using the respective at least one metric, the self-assessment is stored in a memory of the task assessment management system that is accessible to the customer and the contractor;
evaluating the contractor performance in completing each of the plurality of tasks by the customer using the respective at least one metric and the self-assessment;
responding to the customer assessment by the contractor using information relating to the performance of the contractor stored in the database, the information acquired from the customer and the contractor during performance of the task; and
generating a corrective action plan that realigns at least one of the plurality of tasks based on the program objective and the performance of the plurality of tasks up to the assessment.

21. A method in accordance with claim 20 wherein evaluating the contractor performance comprises:
rating by the customer each task and including a comment for each rating in support of the rating;
generating a response by the contractor to the assessment by the customer the response including generating a corrective action plan that is stored in the database that is accessible to the customer and the contractor; and
realigning at least one of the plurality of tasks with the program objective based on the assessment by the customer wherein realigning includes at least one of reallocating resources to the task, and adjusting a time to completion of the task.

22. A method in accordance with claim 20 further comprising generating an assessment by the customer of the contractor performance on each task, the assessment including a weighted fee award for the task.

23. A method in accordance with claim 20 further comprising storing contractor self-evaluations of task completions in a memory of the task assessment management system that is accessible to the customer and the contractor.

24. A method in accordance with claim 20 further comprising determining a fee award based on the performance of the tasks with respect to the associated metric and the information stored in the database.
